(19) United States
(12) Patent Application Publication
(10) Pub. No.: US 2002/0186272 A1
(43) Pub. Date: Dec. 12, 2002

(54) Method and apparatus for improving quality of dormant inkjet printer

(76) Inventors: Martin M. Selak, Mt. Prospect, IL (US); Pawel Pach, Schaumburg, IL (US)

Correspondence Address: Wallenstein & Wagner, Ltd., 53rd Floor, 311 S. Wacker Drive, Chicago, IL, 60606-6630, US

(21) Appl. No.: 09/876,898

(22) Filed: Jun. 7, 2001

(51) Int. Cl. B41J 2/165

(52) U.S. Cl. 347/35

(57) ABSTRACT

The present invention is to a method and apparatus for inkjet printers (200) to improve the performance of the printer and the quality of the output from the printer. The printer (200) includes one or more ink cartridges (20), each with a reservoir (21) for storing ink (15) and a plurality of ports (25) in communications with the reservoir. Control means (2,11) associated with either the printer (200) or a computer (1) instructing the printer, directs the ports (25) to fire or eject ink (15,t) from the reservoir (21) onto the media (100,S) being printed upon while the cartridge (20) and media are moving relative to one another so as to prevent the ink from drying up on the front face (22) adjacent to or over the ports.

### DESCRIPTION

1. Technical Field

The present invention generally relates to inkjet printers, more particularly, to a method and system for preventing the individual ports of an ink cartridge from drying up.

2. Background of the Invention

Inkjet printers are popular and used in a myriad of applications for printing on substrates or media, such as paper, board and plastics. As shown in FIG. 1, generally a computer 1 with its attending software 2 is employed to both input and store the information to be printed. The information is transmitted [via hard wire 3] to the printer 200 with its own software and hardware 11, called firmware. The printer 200 receives the information and temporarily stores the information transmitted from the computer in its memory 12. A substrate 100 is moved, by conveyer, feeder, gripper arms, etc. into the printer's print zone and is printed upon with ink 15. The resulting printings are performed by the printer 200 and controlled or directed by the combination of the instructions transmitted by the computer 1,2,3 and the printer's internal firmware 11.

Turning to FIG. 2, within inkjet printers 200, there are typically one or more cartridges 20 storing ink 15. The ink 15 can be black or other colors. Some cartridges are a single color and others are multicolored. Cartridges 20 often have flanges 23 (FIG. 3) for coupling with brackets (reference number 212 in FIG. 6) in the printers to lock the cartridges in their desired positions or locations relative to the printer and media to be printed upon. Each cartridge 20 has a reservoir 21 (shown in dotted lines in FIG. 3) for storing the ink 15 and a front face 22 with a plurality of very small orifices, jets or ports 25 therein (FIG. 4A, FIG. 4B and FIG. 4C). The ports 25 are in communication with the ink storage chamber 21 and act as passageways between the ink storage chamber and the substrate 100 to be printed upon. There can be hundreds or even thousands of such ports in a single cartridge. Here, FIGS. 4A and 4B show one column of ports and FIG. 4C shows two columns of such ports.

The printer's firmware 11 controls the flow of ink 15 through these ports 25. Each port 25 has two states or conditions controlled electrically, that being “on” for printing and ejecting ink and “off” for remaining dormant, a nonprinting state. Thus, as the substrate 100 passes before the ports 25, each port is either firing ink and printing upon the substrate or dormant. The cumulation and combination of these actions by the ports is the print appearing on the substrate.

To the extent a port remains dormant for an extended period of time, the ink around it can dry up. This can result in hampering the flow of ink or creating an inconsistent flow of ink when the port is next fired. At times, this hampering or inconsistency can be detected in the final printed product, reducing its quality.

For illustrative purposes, FIG. 5 shows a front face 22 with a single column of ports 25 adjacent a substrate 100. One is to assume the face 22 faces the substrate 100 during the printing of the substrate as the substrate passes the face. In printing the letter S, those ports in zone A are engaged at least once as the substrate travels the distance z directly under the column of ports 25. In printing the letter q, those ports in zone B are engaged at least once as the substrate travels the distance y directly under the column of ports 25. The area most susceptible for drying up are those ports in zone C where the “tails” of letters and numbers occur, such as “g,” “j,” “p” and “q.”

To overcome this problem, some manufacturers recommend periodic purging of the cartridge by engaging or momentarily firing all of the ports at once (“|” in FIG. 5). Some manufacturers will instruct the user of the printer to print out certain letters or symbols periodically to engage ports that are often dormant, e.g., extended “I” in FIG. 5). These letters, symbols and purges will often appear on the materials (100) being printed upon. Such unnecessary, unwanted and stray marks naturally affect and diminish the quality of the final printed product.

Accordingly, there is a significant need to prevent the ports from drying up during use while also maintaining quality in the finished product.

### SUMMARY OF THE INVENTION

The present invention is directed to a method of improving the quality of the output from an inkjet printer and the performance thereof. The printer includes an ink cartridge with a reservoir for storing ink and a plurality of ports in communications with the reservoir for ejecting the ink from the reservoir, control means associated with either the printer or a computer instructing the printer for directing the ports to eject ink from the reservoir onto a substrate, and transport means for moving either the ink cartridge relative to the substrate or the substrate relative to the ports. The method of the present invention incorporates the steps of directing select ports to discharge ink while the cartridge and substrate are moving relative to one another. The directions to discharge the ink from the ports after a predetermined period of time is given by a set of instructions given to the printer by the computer or a set of instructions previously stored within the printer. In one embodiment, only one port discharges ink at a time. In another embodiment, two or more ports eject ink simultaneously.

In ink cartridges having one column of ports, the ink is discharged from the ports sequentially. Specifically, if all of the ports are selected to discharge ink, in a column of N collinear ports, identified as port 1, port 2 through port N-1 and port N, the ports will discharge ink sequentially starting with port 1 and continuing through port N. A cycle is competed when all of the ports have discharged ink. The inkjet printer continues performing cycles while the ports and substrate are moving relative to one another. Preferably, the predetermined period of time between each discharge is under a tenth of a second. Also, the distance between traces resulting from the discharged ink is less than an inch.

In ink cartridges having more than one column of ports, the ink is discharged from the ports sequentially, alternating columns after each discharge. For example, if all of the ports are selected to discharge ink, in two columns of a total of N ports, identified as port 1, port 3 through port N-1 in a first column and identified as port 2, port 4 through port N in a second column, the ports will discharge ink sequentially starting with port 1, then port 2, then port 3, continuing through port N-1 followed by port N. A cycle would thus be competed when all of the ports in both columns have discharged ink. Again, the inkjet printer continues performing cycles while the ports and substrate are moving relative to one another.

The above method is intended to have select ports or each and every port discharge ink while at the same time to minimize the visibility of the discharged ink on the media or substrate being printed upon.

The apparatus associated with performing the above method includes the printer and ink cartridges above. A set of instructions given to the printer by the computer or already stored within the printer direct the ink to discharge from the select ports after a predetermined period of time. The select ports can be within a particular zone (e.g., Zone C above) or all of the ports in the cartridge.

These and other aspects of the present invention set forth in the appended claims may be realized in accordance with the following disclosure with particular reference to the accompanying drawings.

### BRIEF DESCRIPTION OF THE DRAWINGS

In the accompanying drawings forming part of the specification, and in which like numerals are employed to designate like parts throughout the same,

FIG. 1 is a block diagram of a computer-printer system;

FIG. 2 is a general diagrammatic view of an inkjet printer;

FIG. 3 is a side elevation view of an inkjet cartridge;

FIG. 4A is an isometric view of the inkjet cartridge;

FIG. 4B is an illustrative diagram of the front face of an ink cartridge having a single column of ports;

FIG. 4C is an illustrative diagram of the front face of an ink cartridge having two columns of ports;

FIG. 5 is an illustrative diagram of the front face of the cartridge and select resultant printings;

FIG. 6 is a diagrammatic cross-sectional view of a printer or labeler;

FIG. 7 is an illustrative diagram of the front face of the cartridge and resultant printings, namely traces, made in accordance with the teachings of the present invention;

FIG. 8 is another illustrative diagram of the front face of the cartridge and resultant traces wherein multiple, serial cartridges are employed; and,

FIG. 9 is an example of the resultant printings made in accordance with the teachings of the present invention.

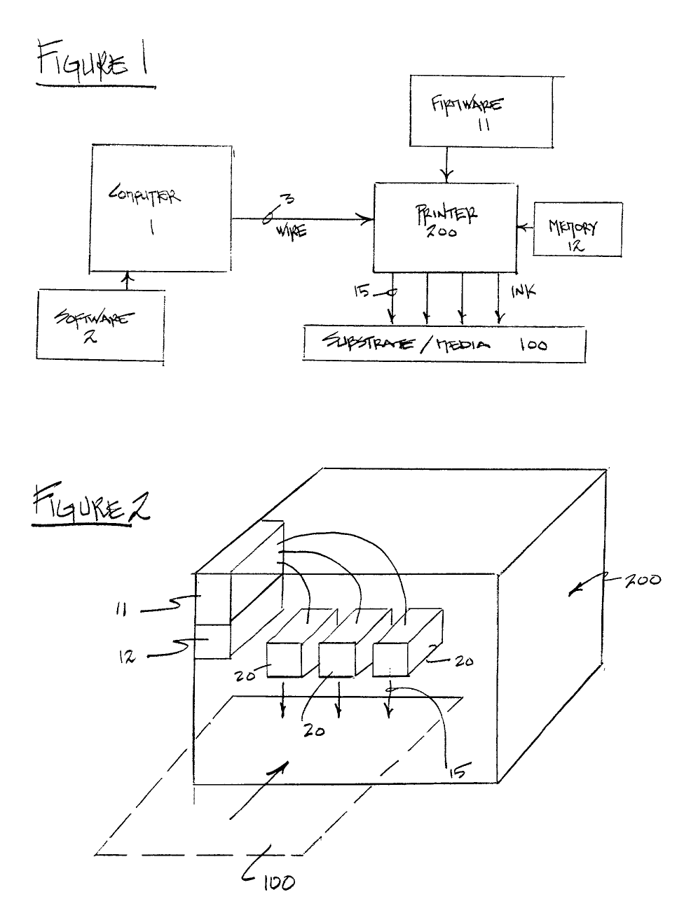

### DETAILED DESCRIPTION

While this invention is susceptible of embodiments in many different forms, there is shown in the drawings and will herein be described in detail preferred embodiments of the invention with the understanding the present disclosure is to be considered as an exemplification of the principles of the invention and is not intended to limit the broad aspect of the invention to the embodiments illustrated.

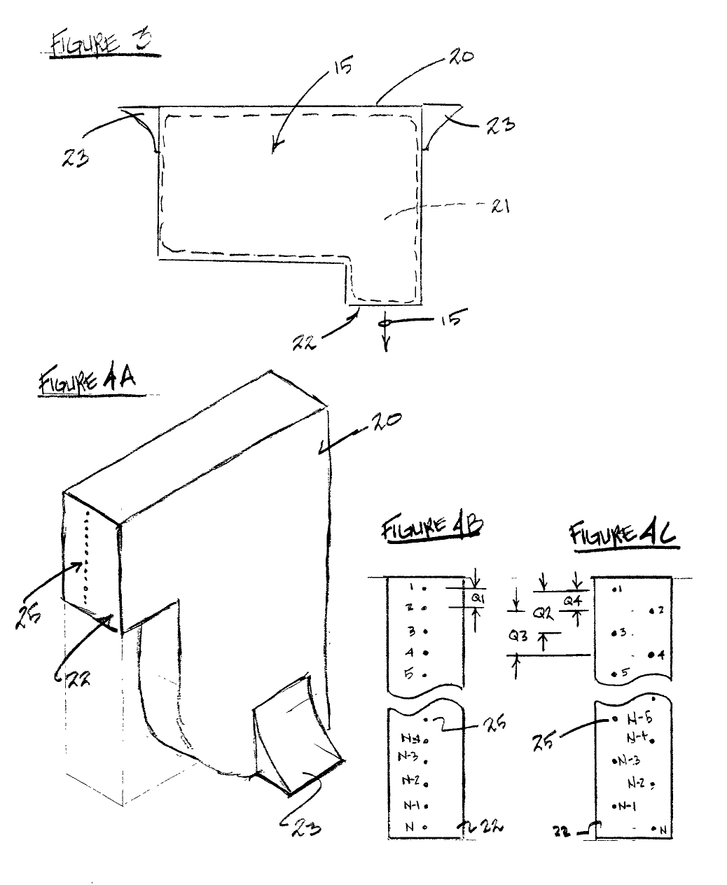

For illustrative purposes, the printer discussed herein as an example is the AstroJet® 1000 Printer with AstroJet Software from ASTRO MACHINE CORPORATION, 630 Lively Boulevard, Elk Grove Village, Ill. 60007. The cartridges used by this printer are HP51645A Print Cartridges, single use cartridges, made by Hewlett-Packard. These cartridges can be easily installed and easily removed. A diagrammatic cross-sectional side view of the printer 200 with the side cover(s) removed is shown in FIG. 6. The printer 200 works much like a standard paper [8-½″×11″] printer in that a stack or deck of media, such as envelopes S, is put into a feeder section 201 of the printer. The feeder section 201 includes a supporting bed 202 for holding and supporting the stack S, two parallel, upwardly extending side guides 203 with inwardly turned flanges 204 for confining and supporting the sides of the envelopes and a moveable stop 205 pressing against the trailing edge of the envelopes S. In the feeder portion 201 of the printer 200, the supporting bed 202 is angled downwardly so as to facilitate in the envelopes' movement and travel downstream (arrow V). By supporting the trailing edge of the envelope above the leading edge, a forward feeding angle is established. The feeder 201 includes a separator 206, well known to those skilled in the industry, for separating the bottommost envelope, the one to be labeled next and directly on the bed, from the adjacent envelopes above it. The separator 209 is adjustable to accommodate media/items of different thicknesses. A plurality of feed rollers 207 takes the separated envelope and feeds it to the printing area or zone 210 in the printer. One or more cross bars 211 in the printing area 210 support a plurality of cartridges 20 thereon. Each cross bar 211 supports one or more brackets 212 and each bracket 212 supports a cartridge 20 by cooperating with the flanges 23 (FIG. 3) on the cartridge 20 to lock the cartridge in a desired position or location relative to the printer.

A plurality of parallel, spaced apart conveyer belts 213 entrained around rollers 214 move the media being printed upon from the feeder section 201 to and through the output opening 220 on top of and along the bed 202. A bin 221 is shown for receiving and collecting the envelopes ejected from the output opening 220. While not shown, it is recognized that there are usually exit rollers associated with the output opening 220 to facilitate the movement of the printed media out of the machine.

Thus, once past the feed rollers 207, the media is transported to and through the printing area 210 on the conveyer belts 213 while being printed upon, and than out of the printer through the exit opening 220. Accordingly, in this example, the media or substrate moves relative to the printing heads or cartridges 20. It is well recognized that in some machines, the cartridges are moved while the media is maintained stationary. The present invention works for both applications.

A transport door (not shown) is provided above the printing zone 210 to permit access to the conveyer belts, rollers, bed, cross bars, brackets and cartridges.

A control panel, shown diagrammatically at reference letter K, is provided on the outer casing of the printer 200. The controls on the panel permit such things as accessing the printer menus, purging the print heads, turning the printer on and off, adjusting the media thickness, resetting the system, running test prints, etc. As noted previously, the printer 200 is connected, via cable (3), to a computer (1) which has its own software (2) associated therewith. The software enables one to identify the media to be labeled (e.g., envelopes), set up templates for the media to be printed upon (e.g., location and style of recipient's address, location and style of return addresses and location and style of any messages) and input different labels from a database (e.g., recipients' names and addresses). Such software is well known in the industry.

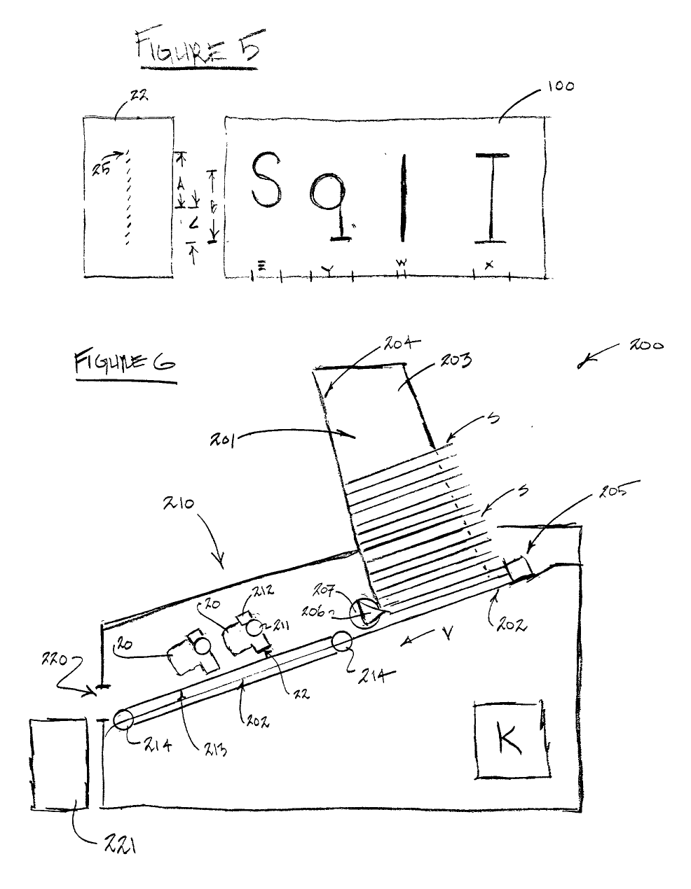

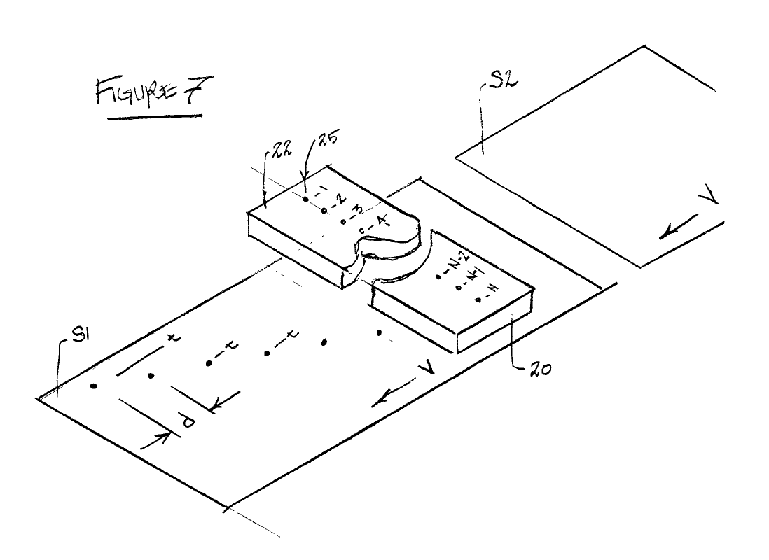

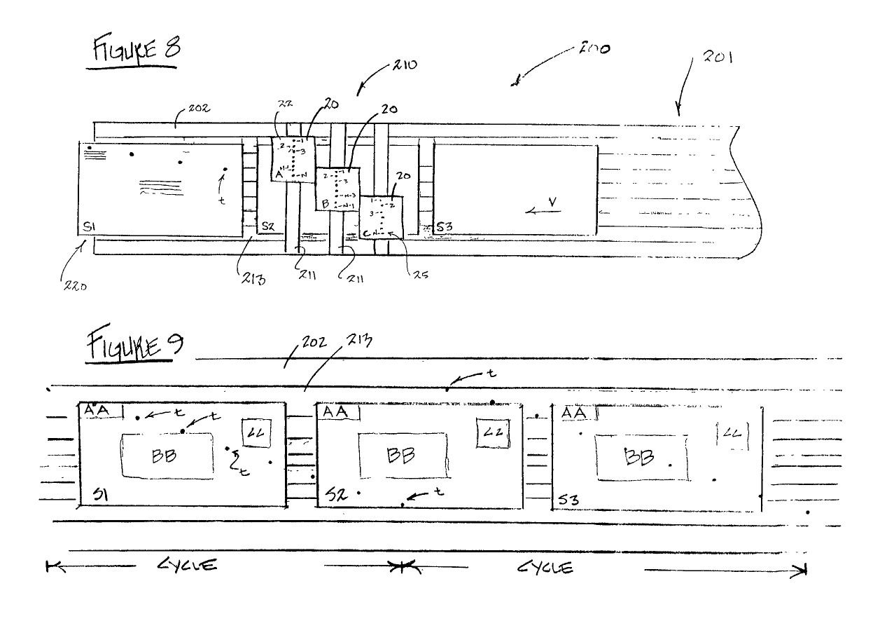

The cartridges 20 used are described in detail above. Briefly, each ink cartridge 20 has an internal reservoir 21 for storing ink 15 and a plurality of ports 25 in communications with the reservoir for ejecting the ink from the reservoir onto the substrate or media to be printed upon. A typical cartridge includes one or more columns of ports 25 on the front face 22. See FIGS. 4B and 4C. The number of ports 25 can, of course, differ. Here, FIG. 7 shows a single column of ports with a total of N ports, numbered from 1 to N, on the cartridge's face 22. The ports 25 are directed to fire ink 15 from the reservoir 21 by either the computer 1 (such as instructions from the user and software 2 within the computer) or the printer 200 itself (e.g., instructions 11 associated with start up, diagnostics, test cycles, or actual use). Thus, while either the media is moving relative to the ink cartridges, or the cartridges are moving relative to the media, the media is being printed upon.

Pursuant to the present invention, each port 25 is directed to eject ink 15 while the cartridge 20 and substrate 100,S are moving relative to one another. This can be accomplished and performed by a set of instruction 2 given to the printer 200 by the computer 1 or by software or firmware 11 already stored within the printer 200 to eject ink 15 from each port 25 in each cartridge 20 after a predetermined period of time. There are several ways to do this. The hardware and software are dependent on the machines employed and operating systems used, but are well known to those in the field. For example, the system can be programmed to eject ink from each port, one at a time (port 1, then port 2, then port 3, etc.) or programmed to eject ink from several ports simultaneously (port 1 and port N, then port 2 and port N-1, then port 3 and port N-2, etc.). FIG. 7 shows the resultant sheets if one port is fired at a time and the firing is performed sequentially (port 1, then port 2, then port 3, etc.). For illustrative purposes, the front face 22 in FIGS. 7 and 8 is facing upwards, away from the media S1,S2,S3 to be printed upon, to show the alignment of the ports 25 and the ejected ink (traces t) on the media. The distance d between traces t is determined by both the speed of the paper (arrow V) through the printing area and the time between firings. As the speed of the paper increases, the traces t become greater and more spaced apart. Similarly, as the time between ejections or firings gets longer, the distance between the traces t becomes greater and more spaced apart.

FIG. 8 shows an example wherein there are three cartridges 20 being employed, each with a single column of N collinear ports 25, identified as port 1, port 2 through port N-1 and port N. In this example, the ports eject ink 15 sequentially starting with port 1 and continuing through port N in the first cartridge 20 (the top one), than the second cartridge (the middle one) and finally the third cartridge (the bottom one). It should be noted that the distance between port N in the first cartridge and port 1 in the second cartridge, is generally the same as the distance between the ports 25 in a column on the same face 22. In the preferred method, all cartridges are fired sequentially and simultaneously. For example, port 1 is fired from all the cartridges simultaneously; then, port 2 is ejected from all of the cartridges simultaneously; next, port 3 is fired from all of the cartridges simultaneously. This continues until port N in all the cartridges is fired simultaneously.

Once a complete cycle has been completed, e.g., all ports have been ejected in all cartridges, the inkjet printer 200 will continue performing cycles while media S1,S2 is still moving through the print zone 210. (See for example, FIG. 9). In the embodiment shown, the cycling of ejections from the ports 25 occur while the conveyer belts 213 are moving.

The traces t themselves are very small. The actual ports are fire drops or droplets as small as ten (10) picoliters. The Hewlett-Packard single use cartridges, HP51645A Print Cartridges, are designed to print 600 dpi vertically and 600 dpi horizontally. They employ thermal ink-jets and non-contact drop-on-demand technology with water-resistant plain paper inks. The Integrated Driver head (IDH) technology coordinates the individual ports through a multiplexing scheme which ejects or fires all the ports through 52 interconnecting pads. Three hundred (300) ports are used. Unlike the illustrated example above having a single column of ports (FIG. 4A), they are broken into two staggered columns (FIG. 4C). The first port, port 1, is in the first column as are all the odd numbered ports. The second port, port 2, is in the second column along with all the even numbered ports. The firing of ports 1, 2, 3, etc. would thus be first from the first column, followed by the second column, then by the first column, etc. The vertical distance between each port in each column (Q2 and Q3) is about 84.75 μm (microns). The effective, actual distance is between sequential ports (Q4) is about 42.25 μm and 42.50 μm. This is roughly the same vertical distance between each trace t. A single trace t has a diameter of approximately one to two thousandths of an inch (0.001″-0.002″) and is virtually undetectable to the human eye. In short, the single firing from each port minimizes the visibility of the ejected ink-traces t—on the substrate. As the number of simultaneous firings escalates, the perceptibility of the traces t increases.

As noted, the distance d between the traces t is partly dependent on the predetermined period of time between ejections. It has been found that times of less than a hundredth of a second (0.01 seconds) are sufficient. Preferably, it has been found that distances d between traces t of about a quarter of an inch (0.250″) work well and look excellent. To obtain this distance, the ports were set to fire 0.01 seconds.

Turning to FIG. 8, a sequential firing of the all the ports in a multi-cartridge system would have the firings of the first set of ports, ports 1-N of the first cartridge 20 (marked A), followed by the firing of the second set of ports, ports 1-N in the second cartridge (marked B), followed by the firing of the third set of ports, ports 1-N of the third cartridge 20 (marked C). This would continue until all of the ports in all of the cartridges were ejected of ink or fired.

The media passing through the printing zone is neither overlapping nor end-to-end abutting one another. There is a space between the media. This is shown in FIG. 9. In the present system, the ports would continue ejecting ink or firing, irrespective of the position of the media underneath the port(s) firing/ejecting. As such, minute spots of ink or traces t will be impinging the machine's bed 202 or conveyer belts 213. Since the machine is wiped clean easily and frequently and the traces affect are de minimus, there is not an issue of build-up affecting the quality of the product or mechanics of the machine. If desired, algorithms can be added to avoid such non-media firings. Sensors may also be employed. FIG. 9 also generally shows the media as it travels past the cartridges and the resultant product (envelopes S1, S2 and S3 where reference letter AA is the return address, BB is the recipient's address, and CC is the postmark). Small traces t appear on the final product that are virtually impossible to see with the unaided eye. Quality of the product is maintained and actually improved upon.

While the specific embodiments have been illustrated and described, numerous modifications come to mind without significantly departing from the spirit of the invention and the scope of protection is only limited by the scope of the accompanying claim.

We claim:

1. A method of improving the performance of an inkjet printer, the printer including:
a) an ink cartridge with a reservoir for storing ink and a plurality of ports in communications with the reservoir for ejecting the ink from the reservoir,
b) control means, associated with either the printer or a computer instructing the printer, for directing the ports to eject ink from the reservoir, and
c) transport means for moving either the ink cartridge relative to a substrate or a substrate relative to the ports,
the method comprising the steps of:
d) directing select ports to eject ink while the cartridge and substrate are moving relative to one another.

2. The method of claim 1 wherein the step of directing select ports to eject ink is performed by a set of instructions given to the printer by the computer or already stored within the printer and includes the instruction to eject ink from the select ports after a predetermined period of time.

3. The method of claim 1 wherein only one port ejects ink at a time.

4. The method of claim 1 wherein two or more ports eject ink simultaneously.

5. The method of claim 1 wherein there is at least one column of ports and the ink is ejected from the ports sequentially.

6. The method of claim 1 wherein there is at least one column of N collinear ports, identified as port 1, port 2 through port N-1 and port N, and all of the ports eject ink sequentially starting with port 1 and continuing through port N.

7. The method of claim 6 wherein a cycle is competed when all of the ports have ejected ink and wherein the inkjet printer continues performing cycles while the ports and substrate are moving relative to one another.

8. The method of claim 7 wherein the predetermined period of time is under a tenth of a second.

9. The method of claim 8 wherein the distance between traces resulting from the ejected ink is less than an inch.

10. The method of claim 1 wherein there are at least two columns of ports and the ink is ejected from the ports sequentially, alternating columns after each ejection.

11. The method of claim 1 wherein there are at least two columns of ports for a total of N ports, identified as port 1, port 3 through port N-1 in a first column and identified as port 2, port 4 through port N in a second column, and wherein all of the ports eject ink sequentially starting with port 1, then port 2, then port 3, continuing through port N-1 followed by port N.

12. The method of claim 11 wherein a cycle is competed when all of the ports in both columns have ejected ink and wherein the inkjet printer continues performing cycles while the ports and substrate are moving relative to one another.

13. The method of claim 12 wherein the predetermined period of time is under a tenth of a second.

14. The method of claim 13 wherein the distance between traces resulting from the ejected ink is less than an inch.

15. A method of improving the quality of the output from an inkjet printer, the printer including:
a) a reservoir for storing ink,
b) a plurality of ports in communications with the reservoir for firing the ink from the reservoir,
c) control means for directing the ports to fire ink from the reservoir, and
d) transport means for moving either the ports relative to a substrate or a substrate relative to the ports,
the method comprising the steps of:
e) directing select ports to fire ink while minimizing the visibility of the fired ink on the substrate.

16. The method of claim 15 wherein the step of directing select ports to fire ink is performed by an instruction set given to or already stored within the printer and includes the instruction to fire ink from select ports after a predetermined period of time while the ports and substrate are moving relative to one another.

17. The method of claim 15 wherein only one port fires ink at a time.

18. The method of claim 15 wherein two or more ports fire ink simultaneously.

19. The method of claim 15 wherein there is at least one column of ports and the ink is fired from the ports sequentially.

20. The method of claim 15 wherein there are at least two columns of ports and the ink is fired from all of the ports sequentially, alternating columns after each firing.

21. An apparatus for improving the performance of an inkjet printer, the printer including:
a) an ink cartridge with a reservoir for storing ink and a plurality of ports in communications with the reservoir for firing the ink from the reservoir,
b) control means associated with either the printer or a computer instructing the printer for directing the ports to fire ink from the reservoir, and
c) transport means for moving either the ink cartridge relative to a substrate or a substrate relative to the ports,
the apparatus comprising:
d) direction means for directing select ports to fire ink while the cartridge and substrate are moving relative to one another.

22. The apparatus of claim 21 wherein the direction means is a set of instructions given to the printer by the computer or already stored within the printer and includes the instruction to fire ink from select ports after a predetermined period of time.

23. The apparatus of claim 21 wherein only one port fires ink at a time.

24. The apparatus of claim 21 wherein two or more ports fire ink simultaneously.

25. The apparatus of claim 21 wherein there is at least one column of N collinear ports, identified as port 1, port 2 through port N-1 and port N, and all of the ports fire ink sequentially starting with port 1 and continuing through port N.

26. The apparatus of claim 25 wherein a cycle is competed when all of the ports have fired ink and wherein the inkjet printer continues performing cycles while the ports and substrate are moving relative to one another.

27. The apparatus of claim 26 wherein the predetermined period of time is under a tenth of a second.

28. The apparatus of claim 27 wherein the distance between traces resulting from the ejected ink is less than an inch.

29. The apparatus of claim 21 wherein there are at least two columns of ports and the ink is fired from all of the ports sequentially and alternating columns after each firing.

30. The apparatus of claim 21 wherein there is at least two columns of ports for a total of N ports, identified as port 1, port 3 through port N-1 in a first column and identified as port 2, port 4 through port N in a second column, and wherein all of the ports fire ink sequentially starting with port 1, then port 2, then port 3, continuing through port N-1 followed by port N.

31. The apparatus of claim 30 wherein a cycle is competed when all of the ports in both columns have fired ink and wherein the inkjet printer continues performing cycles while the ports and substrate are moving relative to one another.

32. The apparatus of claim 31 wherein the predetermined period of time is under a tenth of a second.

33. The apparatus of claim 32 wherein the distance between traces resulting from the ejected ink is less than an inch.
